(19) United States
(12) Patent Application Publication
(10) Pub. No.: US 2020/0225175 A1
(43) Pub. Date: Jul. 16, 2020

(54) ANALYZING SYSTEM

(71) Applicant: HITACHI, LTD., Tokyo (JP)

(72) Inventors: Akiko KAGATSUME, Tokyo (JP); Minseok PARK, Tokyo (JP); Momoyo ENYAMA, Tokyo (JP); Yasuhiro SHIRASAKI, Tokyo (JP); Michio HATANO, Tokyo (JP)

(21) Appl. No.: 16/603,663

(22) PCT Filed: Mar. 16, 2018
(86) PCT No.: PCT/JP2018/010436

§ 371 Date: Oct. 8, 2019

(30) Foreign Application Priority Data
Apr. 27, 2017 (JP) 2017-087828

(51) Int. Cl. G01N 23/2206; G01N 23/2204

(52) U.S. Cl. CPC G01N 23/2206; G01N 23/2204

(57) ABSTRACT

The purpose of the present invention is to provide a multi-coordinated analyzing device that makes it possible to readily observe the same visual field by using a plurality of different kinds of analyzing device and in which observation results for the same visual field are recorded collectively. An analyzing system according to the present invention includes: a first analyzing unit that obtains first observation data by analyzing a sample and that also obtains position information about the analyzed sample; a position setting unit that performs position alignment of the sample on the basis of the position information obtained by the first analyzing unit; and a second analyzing unit that obtains second observation data by analyzing, by using a method different from the method used by the first analyzing unit, the sample placed at the position aligned by the position setting unit (see FIG. 1).

### TECHNICAL FIELD

The present invention relates to an analyzing system that analyzes the same sample by a plurality of methods.

### BACKGROUND ART

In development of high-performance materials, a need to grasp micro surface phenomena is increasing, and it is necessary to obtain a plurality of different kinds of information by using a plurality of analyzing devices. However, an analyzing region is usually a region smaller than 100 μm square, and it is difficult to find and analyze the same position with a different analyzing device for the same sample. Accordingly, it takes a long time to set an analyzing position. Further, observation results acquired by different analyzing devices are stored in the respective analyzing devices, and observation results of the plurality of analyzing devices for the same sample need to be collected from the analyzing devices.

PTL 1 describes a method of inspecting the same place each time by using an ultrasonic flaw inspection device, in which an RFID tag that stores information and past results necessary for inspecting the same place is provided on an object to be inspected.

PTL 2 describes a technique in which an alignment mark is applied to a sample holder to keep the height of a sample constant, so as to easily and quickly observe and analyze the same visual field by different analyzing devices.

### PRIOR ART LITERATURE

### Patent Literature

PTL 1: JP-A-2007-187574

PTL 2: JP-A-2017-501204

### SUMMARY OF INVENTION

### Technical Problem

In PTL 1, a tag that stores an inspection position or a past inspection result is provided on the object to be inspected so that the observation position can be easily specified and the past inspection result can be referred to immediately. However, only inspection by the ultrasonic flaw inspection device is performed, and observation by different kinds of devices may be not supported.

PTL 2 describes a sample holder for observation of the same visual field by different observation devices so that the same visual field can be easily observed. However, storage of observation data is not specifically considered. When a plurality of samples are observed or a plurality of visual fields of the same sample are observed, data of the same visual field may have to be searched and collected from data stored in respective observation devices.

An object of the invention is to provide an analyzing system in which the same visual field can be easily observed by a plurality of analyzing devices and observation results by different analyzing devices are stored on a visual field basis.

### Solution to Problem

In order to solve the above problems, the invention provides an analyzing system that includes: a first analyzing unit that obtains first observation data by analyzing a sample and that also obtains position information about the analyzed sample; a position setting unit that performs position alignment of the sample on a basis of the position information obtained by the first analyzing unit; and a second analyzing unit that obtains second observation data by analyzing, by using a method different from a method used by the first analyzing unit, the sample placed at a position aligned by the position setting unit.

### ADVANTAGEOUS EFFECT

According to the invention, observation of the same visual field by a plurality of different kinds of analyzing device can be easily performed in a short time. Therefore, observation of many visual fields can be performed and a large amount of data can be stored. Further, since observation results of different analyzing devices are stored on a visual field basis, analysis and processing using different kinds of data in the same visual field are facilitated.

### BRIEF DESCRIPTION OF DRAWINGS

FIG. 1 is a schematic diagram showing a sample holder of an analyzing system according to a first embodiment.

FIG. 2 is a block diagram showing a configuration of the analyzing system according to the first embodiment.

FIG. 3 is a schematic diagram in which a reference unit is a scalene triangle.

FIG. 4 is a schematic diagram in which the reference unit is an interdigital.

FIG. 5 is a flowchart showing an analyzing procedure in a first analyzing device.

FIG. 6 is a flowchart showing an analyzing procedure in a second analyzing device.

FIG. 7 shows an example of an observation result by an XRD device.

FIG. 8 shows an example of an observation result by an SEM-EDX device.

FIG. 9 shows an example of an observation result by an AES device.

FIG. 10 shows an example of an observation result by an EBSD device.

FIG. 11 is a schematic diagram showing a sample holder of an analyzing system according to a third embodiment.

### DESCRIPTION OF EMBODIMENTS

Hereinafter, embodiments will be described with reference to the drawings.

### First Embodiment

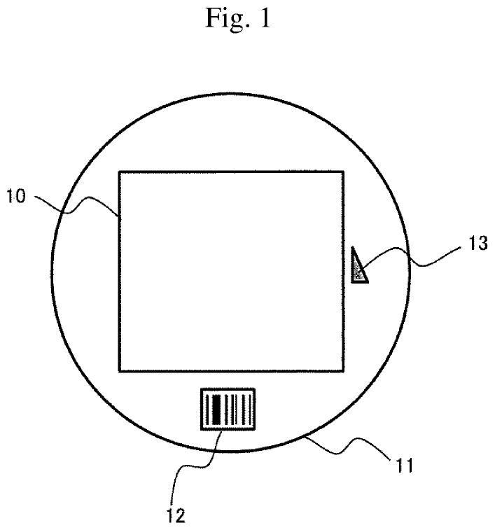

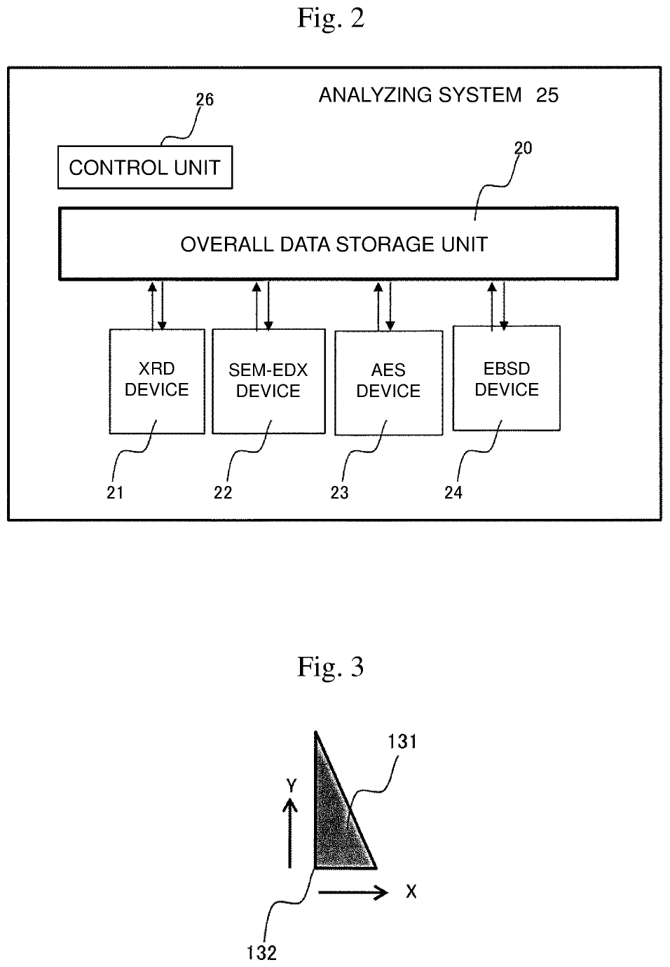

Hereinafter, an embodiment of the invention will be described with reference to FIGS. 1 and 2.

FIG. 1 is a schematic diagram showing a sample holder of an analyzing system according to a first embodiment. FIG. 2 is a block diagram showing a configuration of the analyzing system according to the first embodiment.

An analyzing system 25 performs analysis of a sample in cooperation with a plurality of analyzing devices.

The analyzing system 25 includes an overall data storage unit 20, an XRD device 21, an SEM-EDX device 22, an AES device 23, an EBSD device 24, and a control unit 26. In the present embodiment, the XRD device 21, the SEM-EDX device 22, the AES device 23, and the EBSD device 24 are also simply referred to as an analyzing device or an analyzing unit.

The overall data storage unit 20 stores observation data commonly used by the plurality of analyzing devices. The control unit 26 transmits and receives observation data between the plurality of analyzing devices and the overall data storage unit 20.

The XRD device 21 mainly performs a crystal structure analysis and a compound identification analysis. The SEM-EDX device 22 mainly performs a tissue observation and an elemental analysis. The AES device 23 mainly performs an elemental analysis. The EBSD device 24 analyzes a crystal orientation distribution and a phase distribution.

The XRD device 21, the SEM-EDX device 22, the AES device 23, and the EBSD device 24 each include a sample holder 11, a storage device, and a position setting mechanism.

The sample holder 11 includes a sample 10 to be analyzed, a tag 12 for distinguishing and recognition of a sample, and a reference unit 13 serving as a reference for an analyzing position. The sample 10 to be analyzed is held by the sample holder 11 and installed in each analyzing device.

FIG. 3 shows a schematic diagram in which a reference unit is a scalene triangle. The reference unit 13 records positional information of the sample 10 with an indentation 131 of a scalene right triangle and with a vertex at a right angle as a reference point 132 such that an X direction and a Y direction are distinguished.

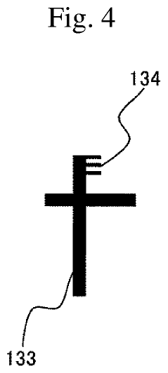

FIG. 4 shows a schematic diagram in which the reference unit is an interdigital. The reference unit 13 may have a comb shape combined by a long thick line 133 and a short thin line 134. In this way, when observing a sample at a low magnification, position alignment is performed by using a long thick line, and when observing a sample at a high magnification, position alignment is performed by using a short thin line, so that it is possible to cope with a change in position alignment accuracy depending on magnification of an analyzing device.

Here, the tag 12 may be a bar code as shown in FIG. 1, a QR code (registered trademark), an RFID, an IC chip, or the like. The tag 12 may be directly applied to the sample 10 instead of being applied to the sample holder 11. The reference unit 13 may be directly applied to the sample 10 instead of being applied to the sample holder 11.

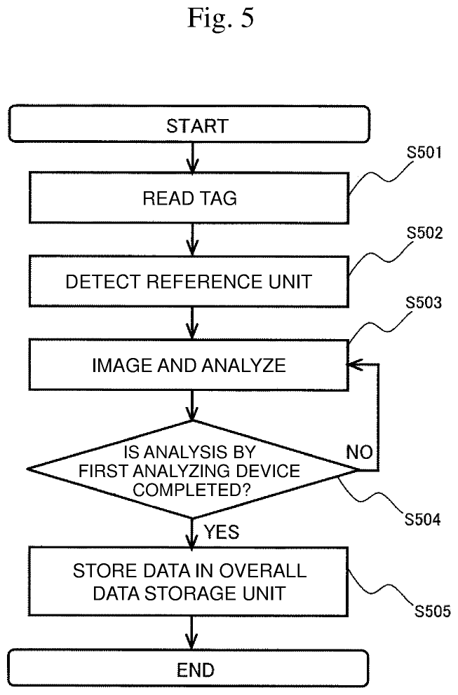

FIG. 5 is a flowchart showing an analyzing procedure in a first analyzing device. First, the control unit 26 reads the tag 12 and stores sample identification information in a storage device contained in the first analyzing device (step 501). Next, the reference unit 13 is detected, and position information of the reference point 132 thereof is stored in the storage device contained in the first analyzing device (step 502).

After that, an observation of imaging, analyzing, and the like by the first analyzing device is performed, and acquired observation data is stored in a storage device contained in the first analyzing device (step 503). A check is made as to whether analysis by the first analyzing device is completed (step 504).

When the analysis by the first analyzing device is not completed, the processing returns to step 503 to adjust an observation target range of the first analyzing device to a position where the sample is desired to be observed, and acquire the analysis position information and observation data of this position. When the analysis by the first analyzing device is completed in step 504, the sample identification information stored in the storage device contained in the first analyzing device, the analyzing position information, and the observation data are stored in the overall data storage unit 20 (step 505), and the analysis in the first analyzing device is completed.

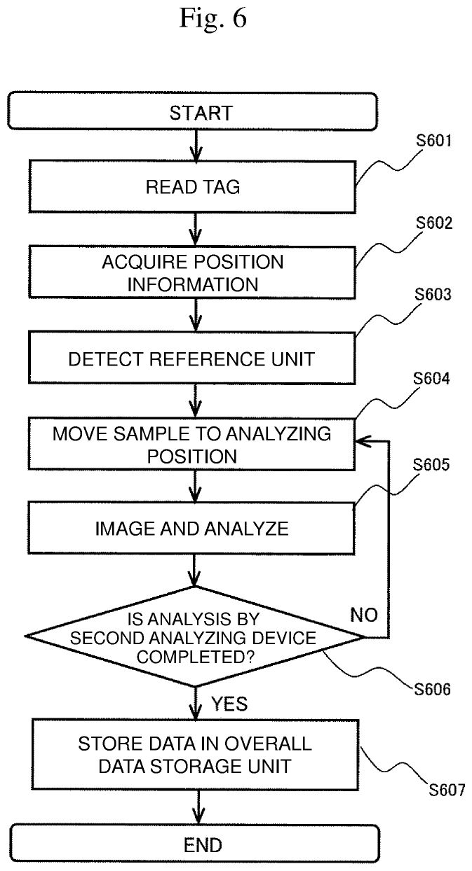

FIG. 6 is a flowchart showing an analyzing procedure in a second analyzing device. First, the control unit 26 reads the tag 12 and stores sample identification information in a storage device contained in the second analyzing device (step 601). Based on the sample identification information, the analyzing position information in the first analyzing device stored in the overall data storage device is read (step 602). When the first analyzing device acquires observation data at a plurality of positions, there are a plurality of pieces of analyzing position information.

Next, the reference unit 13 is detected (step 603), and the sample is moved by using a position setting mechanism based on analyzing position information of the reference point 132 and the analyzing position information acquired in step 602 (step 604).

After that, an observation of imaging, analyzing, and the like by the second analyzing device is performed, and acquired observation data is stored in a storage device contained in the first analyzing device (step 603). A check is made as to whether analysis by the second analyzing device is completed (step 606).

When the analysis by the second analyzing device is not completed, the processing returns to step 604, and the sample is moved by using the position setting mechanism based on another piece of analyzing position information when the observation data is acquired by the first analyzing device (step 604), and the observation data is acquired (step 605). When the analysis by the second analyzing device is completed in step 606, the sample identification information stored in the storage device contained in the second analyzing device, the analyzing position information, and the observation data are stored in the overall data storage unit 20 (step 607), and the analysis in the second analyzing device is completed.

Analyzing procedures in a third and subsequent analyzing devices are performed in the same manner as the analyzing procedure in the second analyzing device. Although the procedure of using the storage device contained in each analyzing device has been described above, data may be directly exchanged with the overall data storage unit 20 without using the storage device contained in each analyzing device.

Here, the analyzing position information is calculated according to a position where the sample is located with respect to the reference point 132 (relative position information). Further, since a visual field level of position setting is different depending on a type of the analyzing device, a certain analyzing device may perform the position setting based on device accuracy information, for example, perform wide position setting with a predetermined margin for the position setting.

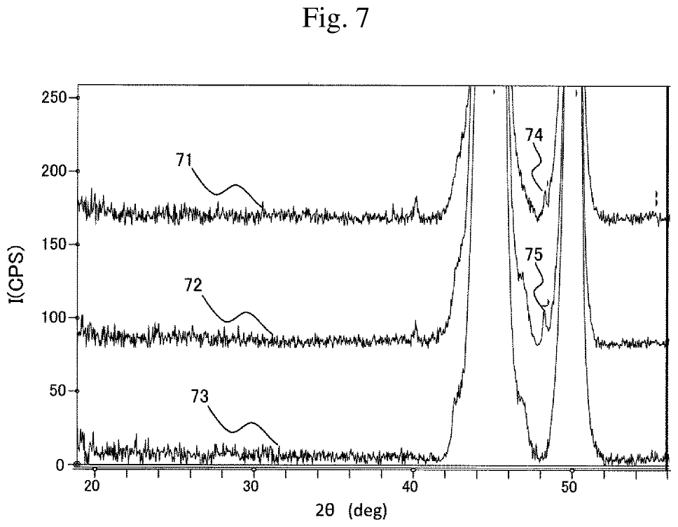

FIG. 7 shows an example of an observation result by the XRD device 21. Peaks (peak 74 and peak 75) of chromium carbide are detected in a spectrum 71 of an analyzing position A and a spectrum 72 of an analyzing position B, and no peak of chromium carbide is found in a spectrum 73 of an analyzing position C.

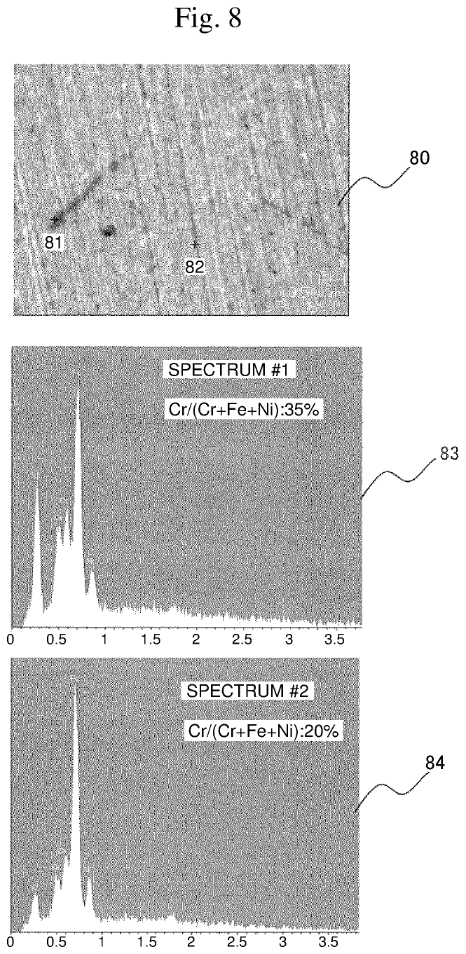

FIG. 8 shows an example of an observation result by the SEM-EDX device 22. When the analyzing position A is observed by the SEM-EDX device 22, a region 81 that appears black along a grain boundary is observed in a secondary electron image 80. From an EDX observation result 83 of the region 81, it can be seen that a ratio of chromium to a total of chromium, iron, and nickel is 35%. A ratio of chromium is 20% according to an EDX observation result 84 of a base material 82, and it can be seen that the ratio of chromium in the region 81 that appears black is larger than that of the base material. Although in the SEM-EDX device 22, information about a depth of about 0.1 μm to 1 μm is detected from a surface, in the AES device 23, information about the vicinity of a surface at a distance of about 0.01 μm from the surface can be obtained and information about an element distribution can be obtained.

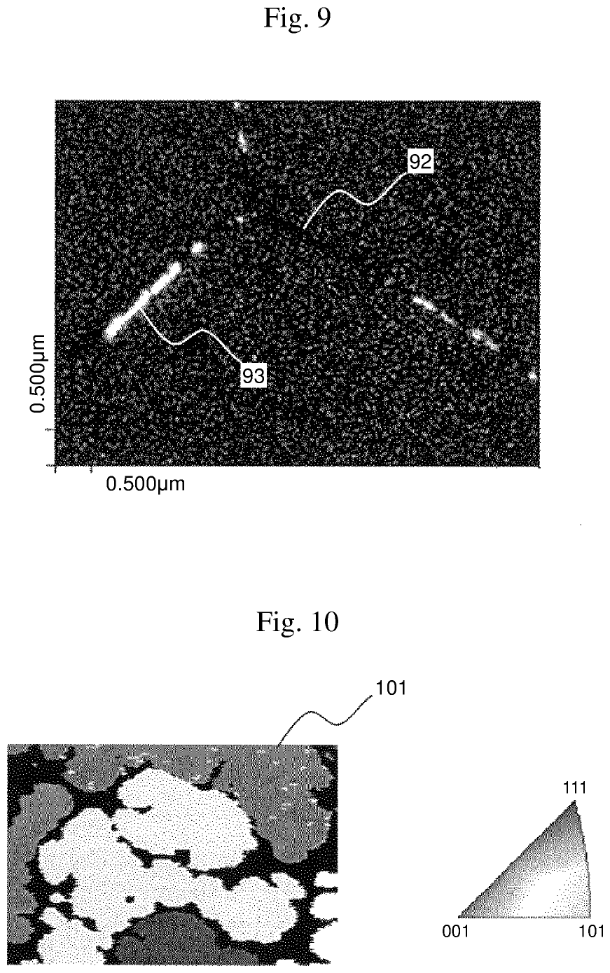

FIG. 9 shows an example of an observation result by the AES device 23. When a distribution of chromium is analyzed by the AES device 23, it can be seen that there are a region 93 having a large amount of chromium and a region 92 having a small amount of chromium along a grain boundary. Since corrosion resistance is reduced when there is a region having a small amount of chromium, it is important to grasp the elemental distribution of a surface in detail so as to know material properties. Next, the EBSD device 24 can analyze the crystal orientation distribution and the phase distribution.

FIG. 10 shows an observation result 101 obtained by observing the crystal orientation distribution by using the EBSD device 24. It is possible to know what kind of crystal orientation grain boundaries are likely to have a region having a large amount of chromium and a region having a small amount of chromium by storing and analyzing the EBSD observation result of the same visual field and the observation results of the SEM-EDX device 22 and the AES device 23. The present embodiment focuses on the ratio of chromium, but the present invention is not limited thereto. For many visual fields, when different kinds of observation results for each visual field can be stored, a large amount of data can be used to search for material property influential factors and predict material properties. Further, material design and process selection for obtaining desired properties may also be possible.

Combination of analyzing devices is not limited to the devices described in FIG. 2, and analyzing devices with different types of information to be obtained may be combined. For example, although an XRD device is shown in FIG. 2 as an analyzing device capable of obtaining information about the surface structure, an analyzing device such as an FT-IR, an LEED, an RHEED, an ISS, and molecular beam scattering may be used. Although EDX and AES are used in FIG. 2 as an analyzing device used for elemental analysis of the surface, an analyzing device such as an EPMA, a TXRF, a PSD, a GDS, a PIXE, an SIMS, and an RBS may be used.

### Second Embodiment

In the first embodiment, various kinds of data are stored in the overall data storage unit 20. In an analyzing system according to a second embodiment, the overall data storage unit 20 is not provided, and various kinds of data are stored in the tag 12 provided in the sample holder 11. The tag 12 has a large storage capacity like an IC chip and can write data. In the second embodiment, since results observed by other analyzing devices can be stored in the same place as a sample, there is an advantage that the data is read quickly, and it is unlikely to mistake data of other samples.

### Third Embodiment

In the first embodiment, a sample holder is moved between a plurality of analyzing devices, and a sample is moved to an appropriate position by a position setting mechanism provided in each analyzing device. In a third embodiment, a stage is newly introduced, and the sample holder 11 and a position setting mechanism are provided on a stage 14. Therefore, each analyzing device may not include a position setting mechanism.

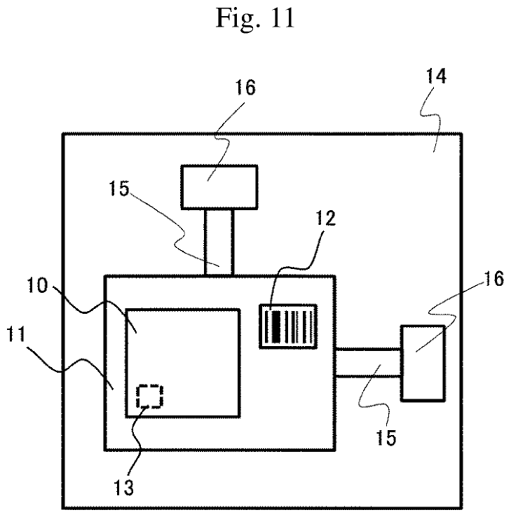

FIG. 11 is a schematic diagram showing a sample holder of an analyzing system according to the third embodiment. The sample holder 11 that holds the sample 10 is installed on the stage 14 having a position setting mechanism including a motor 16 and a movable shaft 15.

A position of the sample is moved without using the position setting mechanism of the analyzing device described in the first embodiment. Since the stage 14 moves between a plurality of analyzing devices, the sample 10 can be placed on a plurality of analyzing devices together with the stage 14 to perform observation. Accordingly, the position setting accuracy differs depending on the analyzing devices, and the problem that it is difficult to observe the same visual field can be solved.

### REFERENCE SIGN LIST

10 . . . sample, 11 . . . sample holder, 12 . . . tag, 13 . . . reference unit, 14 . . . stage, 15 . . . movable shaft, 16 . . . motor, 20 . . . overall data storage unit, 21 . . . XRD device, 22 . . . SEM-EDX Device, 23 . . . AES device, 24 . . . EBSD device, 131 . . . indentation of scalene right triangle, 132 . . . reference point

1.

1. An analyzing system comprising:
a first analyzing unit that obtains first observation data by analyzing a sample and that also obtains position information about the analyzed sample;
a position setting unit that performs position alignment of the sample on a basis of the position information obtained by the first analyzing unit; and
a second analyzing unit that obtains second observation data by analyzing, by using a method different from a method used by the first analyzing unit, the sample placed at a position aligned by the position setting unit.

2. The analyzing system according to claim 1, wherein
a reference point serving as a reference for position alignment of the sample is set on the sample or a sample holder that holds the sample, and
the position information is information indicating a position with respect to the reference point.

3. The analyzing system according to claim 1, further comprising:
a storage unit that stores the position information, wherein
the position setting unit obtains position information for the position alignment from the storage unit.

4. The analyzing system according to claim 3, wherein
the storage unit is provided on a holding holder that holds the sample.

5. The analyzing system according to claim 3, wherein
the storage unit is provided independently of a holding holder that holds the sample.

6. The analyzing system according claim 1, wherein
the position setting unit aligns the sample on a basis of a difference in position setting accuracy levels of a plurality of devices in addition to the position information acquired by the first analyzing unit.

7. The analyzing system according to claim 6, wherein
the difference in the position setting accuracy levels is caused by a difference in appropriate visual field levels determined by the analyzing devices.
